(19) United States
(12) Patent Application Publication
(10) Pub. No.: US 2025/0278634 A1
(43) Pub. Date: Sep. 4, 2025

(54) LARGE LANGUAGE MODELS AS AN ENCODER

(71) Applicant: Roku, Inc., San Jose, CA (US)

(72) Inventors: Kapil Kumar, London (GB); Nitish Aggarwal, Sunnyvale, CA (US); Srimaruti Manoj Nimmagadda, Saratoga, CA (US)

(73) Assignee: Roku, Inc., San Jose, CA (US)

(21) Appl. No.: 18/594,342

(22) Filed: Mar. 4, 2024

(51) Int. Cl. G06N 3/091

(52) U.S. Cl. CPC G06N 3/091

(57) ABSTRACT

Large language models can receive a prompt and generate responses having natural language and/or data structures as sequence of tokens. Some responses may have a few dozen tokens. The speed of response of large language models can be directly proportional to how many tokens are being generated. Rather than producing many tokens, it is possible to fine-tune a large language model to generate responses in an encoded output format. A response can have one or more encoded values that can indicate the same information as a natural language and/or structured data response. The response may include only a single or few tokens. The speed of response of a large language model operating as an encoder would be faster.

### TECHNICAL FIELD

This disclosure relates generally to content item retrieval systems, and more specifically, using a large language model as an encoder in a content item retrieval system.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates an implementation of a content item retrieval system, according to some embodiments of the disclosure.

FIG. 2 illustrates an implementation of context understanding part and a candidate generation part, according to some embodiments of the disclosure.

FIG. 3 illustrates an implementation of context understanding part and a candidate ranking part, according to some embodiments of the disclosure.

FIG. 4 illustrates an implementation of context understanding part that outputs one or more encoded values, and exemplary ways that the one or more encoded values may be used in a content item retrieval system, according to some embodiments of the disclosure.

FIG. 5 illustrates fine-tuning a large language model to output one or more encoded values, according to some embodiments of the disclosure.

FIG. 6 is a flowchart showing a method for content item retrieval, according to some embodiments of the disclosure.

FIG. 7 is a flowchart showing a method for ranking content items, according to some embodiments of the disclosure.

FIG. 8 is a flowchart showing a method for fine-tuning a large language model, according to some embodiments of the disclosure.

FIG. 9 is a block diagram of an exemplary computing device, according to some embodiments of the disclosure.

### DETAILED DESCRIPTION

### Overview

Content platforms offer users access to large libraries of content items. Users can spend a lot of time on a content platform looking for content items to consume. Finding the content items that a user is looking for can be important for user satisfaction. Also, finding the content items quickly can be important for user satisfaction. If a user is not satisfied, the user is likely not going to return to the content platform. Also, if a user is not satisfied, the user is likely not going to consume any content items.

Retrieving content items in response to a query in a way that increases user satisfaction and increases chances of users consuming a retrieved content item is not trivial. A query may include a natural language description of what a user is searching for or looking for in a library of content items. One example of a query may include, “show me some short videos about freshwater shrimp keeping”. The query from a user can be provided as input to a content item retrieval system. The content item retrieval system may return content items that are relevant to the query. Users may expect relevant search results almost immediately or instantly with very little latency or waiting time.

One way to implement a content item retrieval system is to use a self-querying retrieval technique. A large language model is used to reformulate the natural language query from the user and output a data structure and/or a structured query. The data structure and/or the structured query can have attributes about the natural language query. The self-querying retrieval technique can be advantageous because the large language model can understand nuances and contextual cues of the natural language query and produce a context-aware data structure and/or a structured query. Exemplary implementations of the content item retrieval system are illustrated in FIGS. 1-4.

During operation, a large language model can receive a prompt having the natural language query. The large language model may be instructed in the prompt to generate responses having natural language and/or data structures as sequence of tokens. In one example, the large language model may be instructed in the prompt to generate a structured query based on the natural language query. In another example, the large language model may be instructed in the prompt to generate a data structure having attribute-value pairs based on the natural language query. Responses that have natural language and/or data structures may have a few dozen tokens or many more. The speed of response of large language models can be directly proportional to how many tokens are being generated. If responses have many tokens, it can take much more time for the large language model to generate a response, which in turn adds latency to the process of retrieving content items relevant to the natural query back to the user.

Rather than having the large language model produce many tokens, it is possible to fine-tune the large language model to generate responses in an encoded output format. In other words, a large language model may be fine-tuned to operate as an encoder. A response generated by the large language model operating as an encoder can have one or more encoded values that can indicate the same information as a natural language and/or structured data response, but with far fewer tokens. Leveraging the large language model's ability to understand nuances and contextual cues of the natural language query, the one or more encoded values can correspond to or indicate one or more attributes about the natural language query from the user.

Advantageously, the response in an encoded output format may include only a single, a couple, three, or just a few tokens. The one or more encoded values can be efficiently translated using simple logic operations into a structured query and/or parameters, which can be used in configuring the content item retrieval system. In some cases, the one or more encoded values may be used directly as control signals to configure the content item retrieval system. The speed of response of a large language model operating as an encoder and the speed of the logic operations can be still much faster than a large language model that is generating many tokens to form a natural language response or a response having a structured query. By using the large language model operating as an encoder in a content item retrieval system, relevant content items to the natural language query may be returned to the user with lower latency.

Rather than responding to a prompt using natural language or attribute-value pairs, a large language model operating as an encoder may be prompted with an instruction having one or more questions about the natural language query from the user, each question having two or more possible answers. For example, the instruction may include a first question asking a true or false question about the natural language query, and a second question asking a multiple-choice question about the natural language query. The large language model operating as an encoder may respond to the questions using one or more encoded values that indicates a selection of an answer from the two or more possible answers. The large language model may respond to multiple questions in the form of a binary string, e.g., “01”. The large language model may respond to multiple questions in the form of a cipher or symbol, e.g., “B” that corresponds to a particular combination of answers to the questions.

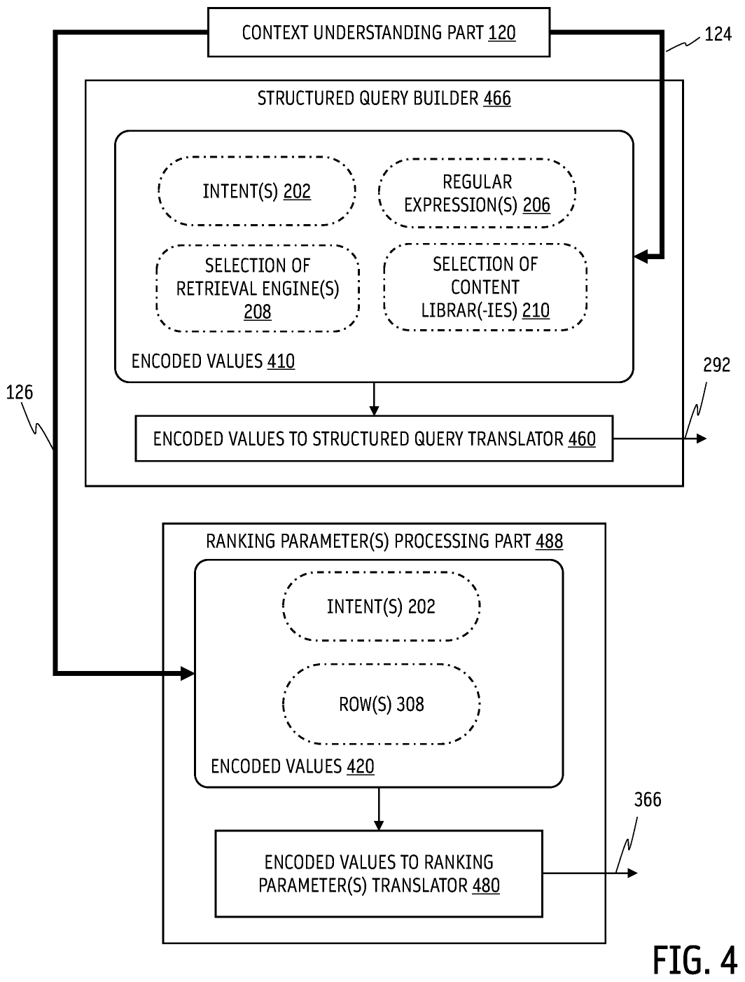

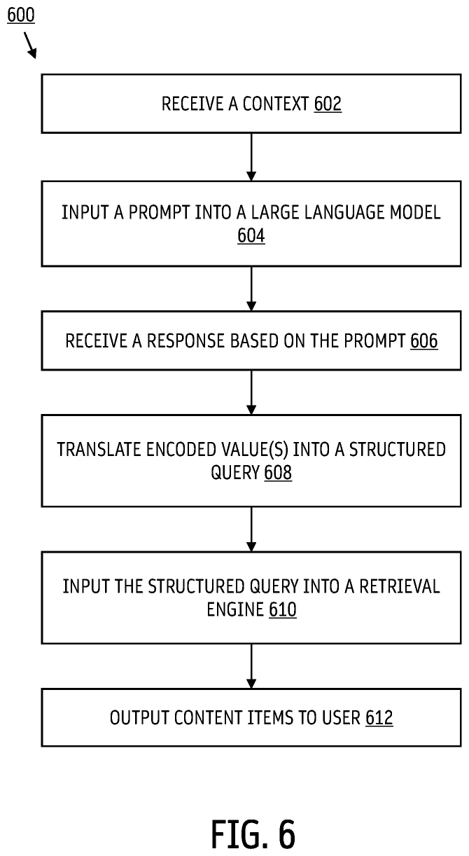

The one or more encoded values can be used as one or more control signals for configuring candidate generation in a content item retrieval system. The one or more control signals can configure parameters for obtaining relevant content items. The one or more control signals can be used by decoding logic to generate a structured query for obtaining relevant content items. Some detailed examples are illustrated in FIG. 4. Exemplary methods for using the one or more encoded values to control or configure candidate generation are described in FIG. 6.

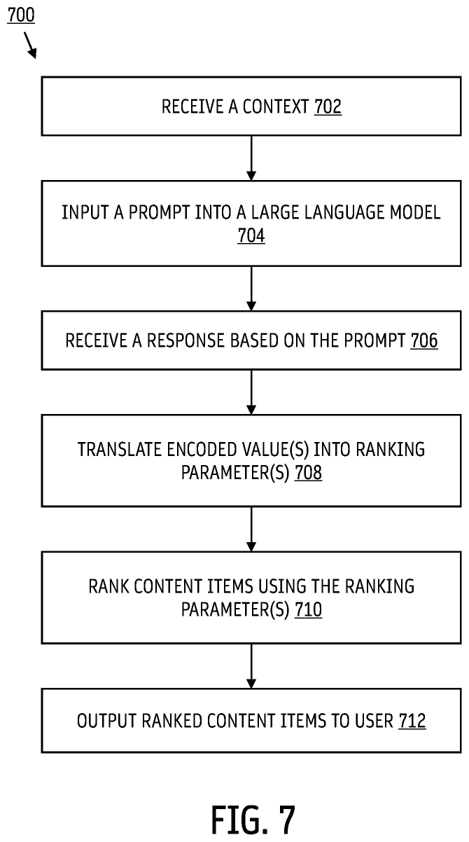

The one or more encoded values can be used as one or more control signals for configuring candidate ranking in a content item retrieval system. The one or more control signals can configure ranking parameters for ranking relevant content items. The one or more control signals can be used by decoding logic to generate ranking parameters for obtaining relevant content items. Some detailed examples are illustrated in FIG. 4. Exemplary methods for using the one or more encoded values to control or configure candidate ranking are described in FIG. 7.

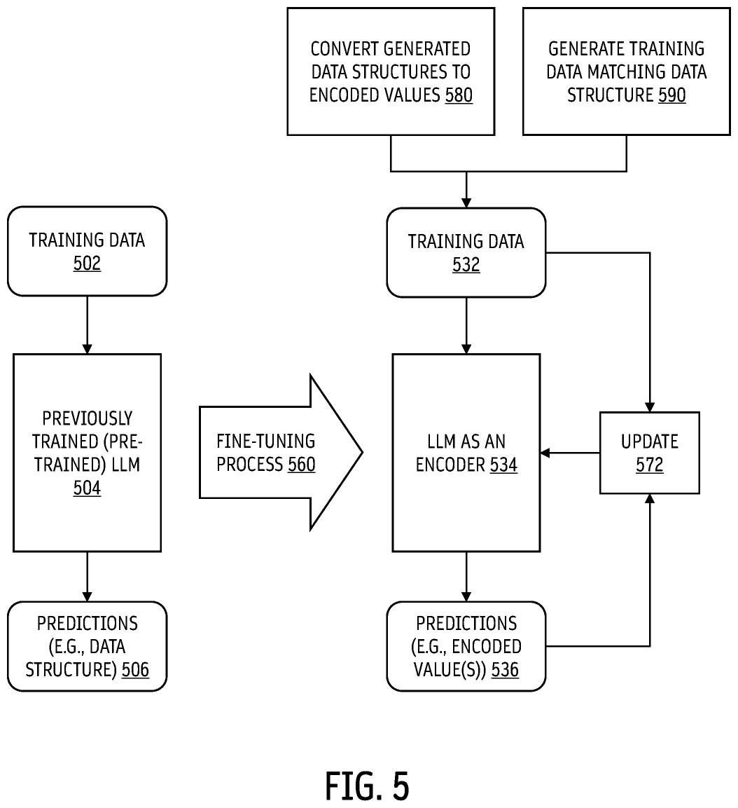

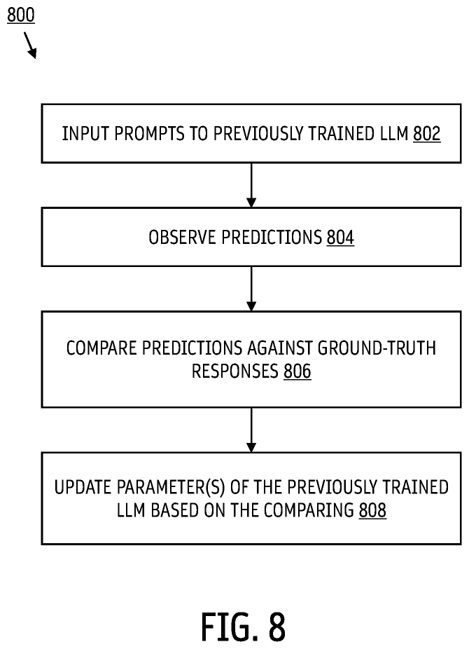

Some techniques can be implemented to generate training data which can be used to fine-tune the large language model to output responses in an encoded output format. The techniques are described in FIG. 5. Exemplary methods for fine-tuning a large language model to output responses in an encoded output format are described in FIG. 8.

While the large language model as an encoder is described in the context of content item retrieval herein, it is envisioned by the disclosure that the large language model as an encoder may be implemented in other systems, e.g., in systems where extraction of attribute(s) based on a prompt may be made quicker by instructing the large language model to generate responses in an encoded output form. As long as attributes can be encoded according to an encoding scheme (and decoded appropriately based on the encoding scheme to resolve the attributes encoded in the response), and a fine-tuning process is implemented to train a large language model to operate as an encoder, the encoding scheme can be provided in the prompt to trigger the large language model to generate responses that have far fewer tokens while conveying the same information.

### Semantic and Contextual Search

Content providers may manage and allow users to access and view thousands to millions or more content items. Content items may include media content, such as audio content, video content, image content, augmented reality content, virtual reality content, mixed reality content, game, textual content, interactive content, etc. Finding exactly what a user is looking for, or finding what the user may find most relevant can greatly improve the user experience. Also, finding relevant content items instantly can also improve the user experience.

FIG. 1 illustrates an implementation of a content item retrieval system 100, according to some embodiments of the disclosure. Context 180 may be provided as input to content item retrieval system 100. Content item retrieval system 100 may include several stages of operations. Content item retrieval system 100 may include one or more of: context understanding part 120, candidate generation part 130, and candidate ranking part 140. Content item retrieval system 100 may generate results 106.

Context 180 may capture context of a particular search or recommendation session with a user. Context 180 may capture information that may be helpful for understanding what a user is looking for and/or what may be relevant or useful to the user. In some cases, context 180 may include query 102.

Query 102 may include natural language text and/or description provided by a user. Query 102 may include a natural language query. In some cases, query 102 may include a user-provided voice-based or text-based query to find content items. Examples of query 102 may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?”
“I want to see a film set in Tuscany but is not dubbed in English” and
“Recommend me movies of Brad Pitt that are free for me to watch”

In some cases, context 180 may include query 102 and optionally one or more contextual factors 170. Examples of contextual factors 170 can include: characteristic(s) about the user making the query, time of day, day of the week, time of the year, seasonality (e.g., seasons, special events, holidays, etc.), one or more past queries made by the user, one or more past user interactivity information with the content platform (e.g., what the user clicked on, etc.), whether the query is voice-based or text-based, the type of device that the user is using (e.g., mobile device versus television), the type of application that the user is using, whether the user is a paid subscriber or not, what subscriptions the user has, demographics about the user, whether the user is an expert/experienced user or not, whether the user is a loyal user or not, how many retrieved content items the user is looking for, characteristic(s) about the device the user is using to input the natural language query, the amount of bandwidth the user has on a network to receive content, etc.

Context 180 may be provided as input to context understanding part 120. Context understanding part 120 may process context 180 to understand context 180, e.g., to extract contextual cues, semantic meaning, user intent, etc. In some cases, context understanding part 120 may implement a large language model. A prompt may be generated based on context 180, and the prompt may be used as input to the large language model. Context understanding part 120 may process context 180 (e.g., receive a prompt that has information about context 180 and an instruction having questions about context 180) and extract one or more attributes or other suitable information about context 180.

The one or more extracted attributes or other suitable information may be provided to candidate generation part 130 to find semantically and/or contextually relevant candidates, e.g., content items semantically and/or contextually relevant to context 180. Candidate generation part 130 may find candidates that are semantically and/or contextually relevant to context 180.

The one or more extracted attributes or other suitable information may be provided to candidate ranking part 140 to augment ranking of relevant candidates, e.g., content items relevant to context 180. Candidate ranking part 140 may determine a score for each relevant candidate found by candidate generation part 130 and sort the relevant candidates based on the scores to produce ranked relevant candidates.

In some cases, context understanding part 120 may generate one or more control signals based on context 180, or output information about context 180.

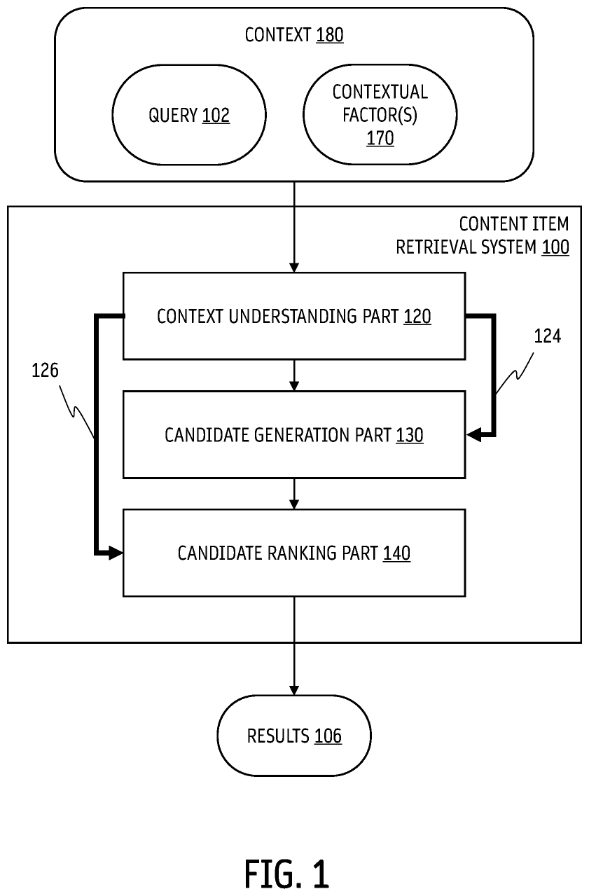

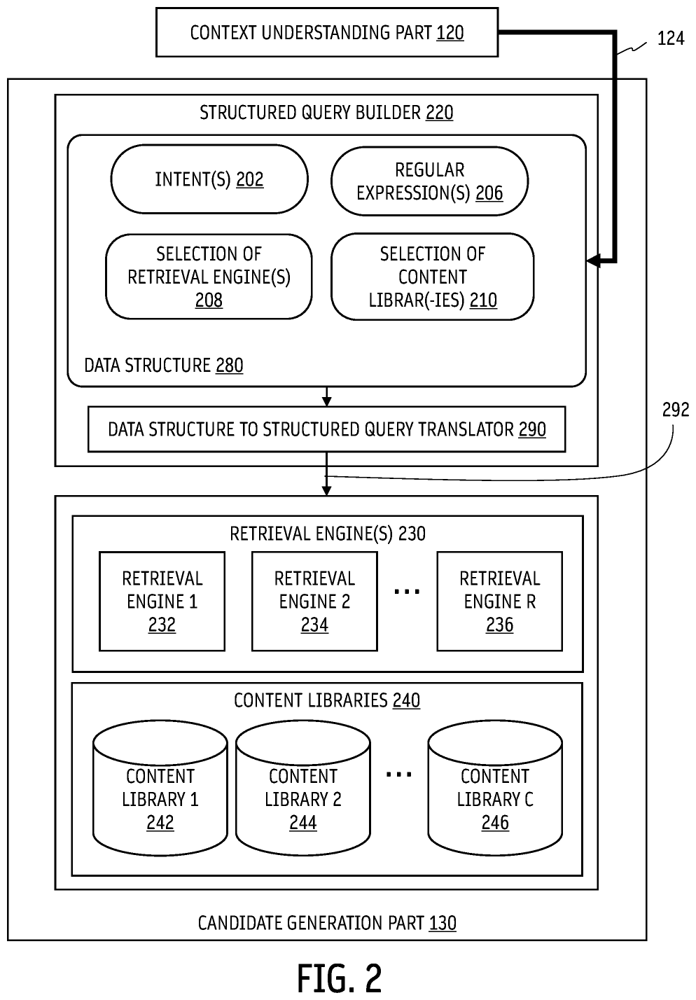

The one or more control signals and/or information may be provided to candidate generation part 130 via path 124. In some cases, the one or more control signals and/or information may control or configure candidate generation part 130. Details about how context understanding part 120 may control or configure candidate generation part 130 are described with FIGS. 2 and 4.

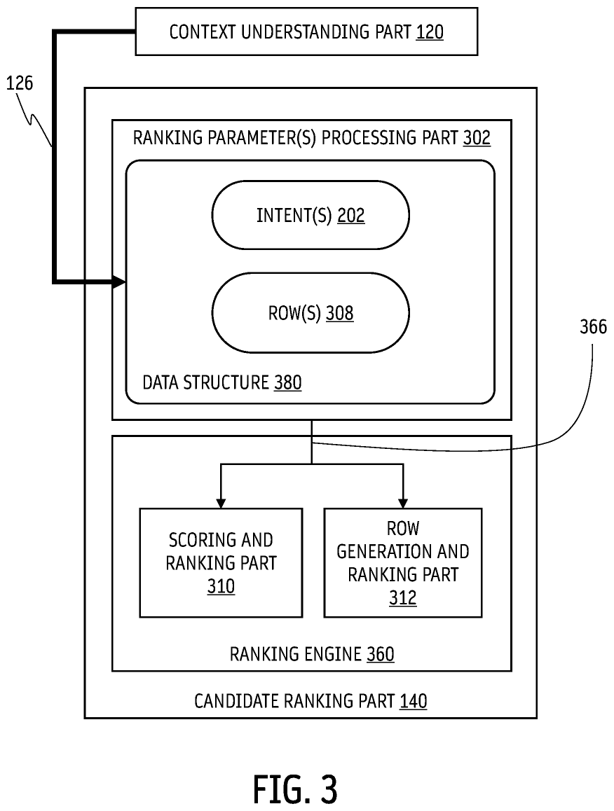

The one or more control signals and/or information may be provided to candidate ranking part 140 via path 126. In some cases, the one or more control signals and/or information may control or configure candidate ranking part 140. Details about how context understanding part 120 may control or configure candidate ranking part 140 are described with FIGS. 3 and 4.

Based on information from context understanding part 120, candidate generation part 130 may determine and output relevant candidates to context 180. Relevant candidates may be provided to candidate ranking part 140 for ranking. Candidate ranking part 140 may determine and output ranked candidates.

Content item retrieval system 100 may return results 106 having ranked relevant candidates, e.g., content items relevant to context 180. Results 106 may be returned to the user who provided or input query 102. Results 106 may be output (e.g., rendered for display) to the user. Results 106 may be output to the user according to the ranking determined in candidate ranking part 140.

### Self-Querying Technique: Extracting Attributes Using a Large Language Model and Applying the Attributes in Candidate Generation

FIG. 2 illustrates an implementation of context understanding part 120 and a candidate generation part 130, according to some embodiments of the disclosure. As discussed previously context understanding part 120 may be implemented to understand the context (e.g., context 180 of FIG. 1). The understanding of the context may be used to generate a structured query 292 which may be used by candidate generation part 130 to generate candidates. Candidate generation part 130 may include one or more retrieval engines 230. Candidate generation part 130 may include one or more content libraries 240. The structured query 292 can be applied to one or more content libraries 240 using one or more retrieval engines 230 to retrieve relevant candidates from the one or more content libraries 240.

One or more retrieval engines 230 may include retrieval engines employing different retrieval algorithms or strategies. One or more retrieval engines 230 may include R number of retrieval engines that may employ different retrieval strategies, e.g., retrieval engine 1 232, retrieval engine 2 234, . . . , and retrieval engine R 236. One example of a retrieval strategy is lexical match. In lexical match search, the query may be processed to extract keywords, and the keywords may be lexicographically matched against a database of content items and associated keywords. Content items which may have the greatest number of keyword lexicographic matches may be returned in response to the query. Another example of a retrieval strategy is semantic retrieval. Semantic retrieval may utilize a model to interpret the semantic meaning or context of a query and find content items that may match with the query. A model may implement natural language processing to interpret the query. A model may involve neural networks (e.g., transformer-based neural networks). A model may include a large language model. Yet another example of a retrieval strategy is a graph embedding based approach to content item retrieval. A graph embedding based approach may find a subgraph of a graph of content items which may be engaging to the user for a given query. In some cases, the graph may model relationships between content items. In some cases, the graph embedding based approach may utilize the graph to identify content items which may not be directly connected to an initial set of content items that matches the query. Yet another example of a retrieval strategy may involve returning a fixed set or list of results for a particular query. The set or list of results may be curated by editor(s), hardcoded, or predetermined. For example, a query for “presidential debate” may retrieve predetermined content items which are tapings of the most recent presidential debates, and not content items related to presidential inaugurations or state of the union addresses. Yet another example of a retrieval strategy may involve searching for content items based on user query history and/or user interactivity history information. For example, content items may be retrieved based on whether the user has launched a particular content item in the past. Yet another example of a retrieval strategy may involve searching for content items based on user profile or user characteristic(s). For example, content items may be retrieved based on demographic information about the user. Yet another example of a retrieval strategy may involve collaborative filtering. Content items may be retrieved based on interactivity with the content platform and characteristics about various users on the system. For example, content items may be retrieved based on content items viewed by users who may be similar to the current user making the query. Users may be similar to the current user if the users behaved similarly on the content platform. Users may be similar to the current user if the users are socially connected with the current user. Yet another example of a retrieval strategy may involve returning a number of content items from each clusters or buckets of content items. For example, content items may be clustered based on type or verticals (e.g., music, book, short videos, long videos, audio-only, live content, games, etc.), and a certain number of content items from each type may be returned as retrieved content items to diversify the types of content items being retrieved. The retrieved content items may have a balance of different types of content items.

One or more content libraries 240 may include libraries having different collections of content items. Candidate ranking part 140 may include C number of content libraries, e.g., content library 1 242, content library 2, 244, . . . , and content library C 246. Examples of content libraries may include: content items available with a particular subscription, free content items, free content items with advertisements, content items of a certain type (e.g., audio, video, podcasts, shorts, books, games, etc.), content items of a certain genre (e.g., thriller, sci-fi, comedy, drama, documentary, etc.), content items which are popular, content items which are not popular, content items belonging to a particular time period, content items available for purchase, content items having a certain seasonality, content items of a certain length, content items in a particular language, content items originating from a particular region or country, content items owned by a particular distributor, content items having a certain parental rating, etc.

In some embodiments, generating a structured query 292 may include a two-stage process. The illustration in FIG. 2 illustrates an exemplary implementation of a two-stage process.

In a first stage of the two-stage process, one or more first large language models or suitable natural language processing models, e.g., in context understanding part 120, may be used to extract one or more attributes about the context and produce a data structure, e.g., data structure 280, that has the one or more attributes. Context understanding part 120 may provide data structure 280 to structured query builder 220 via path 124. One or more attributes may be associated with an intent of the user or the context. One or more attributes may be associated with a regular expression that appeared in the context. One or more attributes may correspond to a retrieval engine in one or more retrieval engines 230. One or more attributes may correspond to a content library in one or more content libraries 240.

Data structure 280 may include attribute-value pairs. Data structure 280 may include an array of attributes (e.g., values corresponding to attributes). Data structure 280 may include one or more intents 202. Data structure 280 may include one or more regular expressions 206. Data structure 280 may include a selection (or indication) of one or more retrieval engine(s) 208. Data structure 280 may include a selection (or indication) of one or more content libraries 210.

The one or more attributes may include one or more intents 202 about the user and/or the context. A large language model may be particularly useful for extracting one or more intents 202 due to the large language model's ability to understanding contextual cues and nuances. One or more intents 202 may indicate what kind, type, or category of content items the user is searching for. One or more intents 202 may indicate one or more filters to be used in candidate generation part 130. Examples of one or more intents 202 may include:
Does the user intend to watch free content?
Does the user intend to watch content that requires an active subscription?
Does the user intend to watch content that can be purchased?
Does the user intend to watch popular content or unpopular content?
Does the user intend to watch content that is new to the user?

The one or more attributes may include one or more regular expressions 206. One or more regular expressions 206 may include text or one or more strings, e.g., a name, a label, a tag, a genre, a title, a word, a keyword, a synopsis, a date, a year, a phrase, etc. A natural language processing model may be particularly useful for extracting one or more regular expressions 206 from the context. A large language model may also be useful for extracting one or more regular expressions 206 from the context. One or more intents 202 may indicate certain text or character patterns to be used in candidate generation part 130.

The one or more attributes may include a selection of one or more retrieval engine(s) 208 that is determined based on the context. The context may suggest one or more ones of one or more retrieval engines 230 may be more suitable or best for the context. Selection of one or more retrieval engine(s) 208 may indicate which retrieval engine to use in candidate generation part 130. For example, a query having, “Can you suggest a scary movie to me that I'd like because I just watched ‘World's Scariest Black Cat’?” may lead to a response having one or more attributes that indicate one or more retrieval engines in one or more retrieval engines 230 may be more suitable over others (e.g., a retrieval engine employing collaborative filtering, a retrieval engine employing searching for content items based on user history/interactivity on the content platform).

The one or more attributes may include a selection of one or more content libraries 210 based on the context. The context may suggest one or more ones of one or more content libraries 240 may have specific content items that the user is searching for. Selection of one or more content libraries 210 may indicate in which one or more content libraries to look for content items in candidate generation part 130. For example, a query having, “What's a good French-language PG-13-rated movie available for free without advertisements?” may result in a response having one or more attributes that indicate one or more content libraries in one or more content libraries 240 may be more suitable over others (e.g., content library having free content items, content library having PG-13-rated movies, content library having French-language content items).

In some cases, selection of one or more retrieval engine(s) 208 and/or selection of one or more content libraries 210 may be derived from one or more intents 202.

To extract one or more attributes from the context, a large language model in the first stage may receive a prompt that instructs the large language model to respond by generating a data structure that has the one or more attributes, such as data structure 280. An example of a prompt may include:

PROMPT

Respond as a JavaScript Object Notation data structure with following fields 1.free_for_me
2.new_to_me 3.subscription 4. popular for the query: Recommend science fiction films
available for free streaming that I haven't seen yet.
free_for_me denote whether user is interested in free content
new_to_me denote whether user is looking for new content
subscription denote whether user is interested in content that the user already has a
subscription for
popular denote whether user is interested in popular content

An example of a response having a data structure may include:

RESPONSE

{free_for_me true, new_to_me true, subscription false, popular false}

The example above may include four attribute-value pairs, “free_for_me true”, “new_to_me true”, “subscription false”, “popular false”. The four fields may be the attributes. The true/false values may be the corresponding values to the attributes.

Candidate generation part 130 and/or context understanding part 120 may include structured query builder 220 to produce a structured query 292 based on the understanding of the context, e.g., the attributes about the context. In some cases, in the first stage, context understanding part 120 may output one or more attributes about the context in the form of data structure 280 and provide the attributes (e.g., via path 124) in the form of data structure 280 to structured query builder 220. The attributes may include information to build structured query 292. Structured query builder 220 may produce structured query 292 based on data structure 280.

In a second stage of the two-stage process, a second large language model or logic may be used, e.g., in data structure to structured query translator 290 of structured query builder 220 to translate the data structure 280 into structured query 292 that can be applied to one or more content libraries 240 using one or more retrieval engines 230 to retrieve relevant candidates from the one or more content libraries 240.

The structured query 292 may follow conventions and/or syntax (or examples thereof) that is accepted or required by one or more retrieval engines 230. Structured query 292 may include coded instructions/parameters to filter content items based on one or more intents 202. Structured query 292 may include coded instructions/parameters to find matching content items based on one or more regular expressions 206. Structured query 292 may include coded instructions/parameters to select, turn on, or use, one or more selected ones of one or more retrieval engines 230. Structured query 292 may include coded instructions/parameters to disable or turn off one or more selected ones of one or more retrieval engines 230. Structured query 292 may include coded instructions/parameters to select or use one or more selected ones of one or more content libraries 240. A large language model in the second stage may receive a prompt that instructs the large language model to respond by generating a structured query, such as structured query 292, that follows a certain convention/syntax and that matches the data structure, such as data structure 280.

An example of the structured query 292 may include:

StructuredQuery(query=‘taxi driver’, filter=Operation(operator =< Operator.AND: ‘and’>,
arguments=[Comparison (comparator =< Comparator.EQ: ‘eq’>, attribute=‘genre’,
value=‘science fiction’), Operation(operator=<Operator.AND: ‘and’>,
arguments=[Comparison(comparator=<Comparator.GTE: ‘gte’>, attribute=‘year’, value=1990),
Comparison(comparator=<Comparator.LT: ‘It’>, attribute=‘year’, value=2000)]),
Comparison(comparator=<Comparator.EQ:‘eq’>, attribute=‘director’, value=‘Luc Besson’)]),
limit=None)

In some embodiments, generating a structured query may include a one-stage process. A large language model may be used, e.g., in context understanding part 120, to directly produce a structured query, e.g., structured query 292, that can be applied to one or more content libraries 240 using one or more retrieval engines 230 to retrieve relevant candidates from the one or more content libraries 240.

Both the two-stage process and the one-stage process can suffer from long wait times due to the number of tokens involved in the responses having a data structure and/or a structured query.

### Contextual Ranking Technique: Extracting Attributes Using a Large Language Model And Applying the Attributes in Candidate Ranking

FIG. 3 illustrates an implementation of context understanding part 120 and a candidate ranking part 140, according to some embodiments of the disclosure. As discussed previously context understanding part 120 may be implemented to understand the context (e.g., context 180 of FIG. 1). Candidate ranking part 140 may include ranking parameter(s) processing part 302. Candidate ranking part 140 may include ranking engine 360. The understanding of the context from context understanding part 120 may be provided to ranking parameter(s) processing part 302. The understanding of the context may be used by ranking parameter(s) processing part 302 to generate one or more ranking parameters 366. One or more ranking parameters 366 may be used by candidate ranking part 140 when ranking candidates. One or more ranking parameters 366 produced by ranking parameters processing part 302 may configure or augment how relevant candidates found by candidate generation part 130 (of FIGS. 1-2) may be ranked or sorted by ranking engine 360. Ranking engine 360 may include scoring and ranking part 310. Ranking engine 360 may include row generation and ranking part 312.

One or more large language models or suitable natural language processing models, e.g., in context understanding part 120, may be used to extract one or more attributes about the context and produce a data structure, e.g., data structure 380, that has the one or more attributes. Context understanding part 120 may provide data structure 380 to ranking parameter(s) processing part 302 via path 126. One or more attributes may be associated with an intent of the user or the context. One or more attributes may be associated with one or more rows that may be relevant or of interest to the user or the context.

In some cases, relevant candidates may be output to a user in rows or groups of content items. A row may correspond to a subcategory or subgroup. A row may correspond to a tag, a characteristic, or a dimension about content items. Examples of rows may include: “popular”, “new to you”, “has strong female-leads”, “1990s throwback”, etc. Rows may help organize/arrange/divide relevant candidates into smaller subgroups, which may help the user browse and find content that the user is looking for more easily or quickly.

Data structure 380 may include attribute-value pairs. Data structure 380 may include an array of attributes (e.g., values corresponding to attributes). Data structure 380 may include one or more intents 202. Data structure 380 may include one or more rows 308.

The one or more attributes may include one or more intents 202 about the user and/or the context. Ranking parameter(s) processing part 302 may translate one or more intents 202 into one or more ranking parameters 366 usable by scoring and ranking part 310. For example, ranking parameter(s) processing part 302 may determine that one or more intents 202 indicate the user is looking for content available with subscription. Ranking parameter(s) processing part 302 may assign a weight or boosting parameter that can make content available with subscription rank higher in the results. Ranking parameter(s) processing part 302 may produce a weight or boosting parameter and provide the weight or boosting parameter as part of one or more ranking parameters 366. Scoring and ranking part 310 may use the weight or boosting parameter as part of one or more ranking parameters 366 when assigning scores to relevant candidates. Scoring and ranking part 310 may then rank/sort the relevant candidates according to the scores.

The one or more attributes may include one or more rows 308 may be relevant or of interest to the user or the context. Ranking parameter(s) processing part 302 may translate one or more intents 202 into one or more ranking parameters 366 usable by row generation and ranking part 312. For example, ranking parameter(s) processing part 302 may determine that one or more rows 308 indicate the user may be interested looking for content having these dimensions: “watch again”, “cult classics”, and “inspired by Mel Brooks”. Ranking parameter(s) processing part 302 may assign filters based on the one or more rows 308. Ranking parameter(s) processing part 302 may produce the filters and provide the filters as part of one or more ranking parameters 366. Row generation and ranking part 312 may use the filters as part of one or more ranking parameters 366 to create subgroups of relevant candidates. Row generation and ranking part 312 may determine scores for the relevant candidates. Row generation and ranking part 312 may use the filters may rank/sort the relevant candidates within each subgroup separately according to the scores.

Using a large language model to produce data structure 380 would suffer from long wait times due to the number of tokens involved in the responses having a data structure such as data structure 380.

### Addressing the Speed of Response of the Large Language Model by Modifying the Large Language Model to Produce Responses in an Encoded Output Format

Referring back to FIGS. 2-3, one or more large language models may be implemented, e.g., in context understanding part 120, to produce one or more of: a data structure, and a structured query. These large language models may be slow due to the large language models having to generate a few dozen or more tokens. Instead of using such language models, a language model operating as an encoder may be implemented instead.

FIG. 4 illustrates an implementation of context understanding part 120 that outputs one or more encoded values, and exemplary ways that the one or more encoded values may be used in a content item retrieval system, according to some embodiments of the disclosure. Rather than passing on attributes and/or data structures to structured query builder 220 via path 124, context understanding part 120 may output one or more encoded values 410 to structured query builder 466 via path 124. Structured query builder 466 can include a modified implementation (when compared to structured query builder 220 of FIG. 2) to utilize one or more encoded values 410 to generate a structured query 292. Rather than passing on attributes and/or data structures to ranking parameter(s) processing part 302 via path 126, context understanding part 120 may output one or more encoded values 420 to ranking parameter(s) processing part 488 via path 126. Ranking parameter(s) processing part 488 can include a modified implementation (when compared to processing part 302 of FIG. 3) to utilize one or more encoded values 410 to generate one or more ranking parameters 366.

A content item retrieval system may implement one or more decoder functions to decode the response having one or more encoded values (e.g., one or more encoded values 410 and one or more encoded values 420). The one or more decoder functions may determine one or more attributes to which the one or more encoded values in the response correspond. The one or more decoder functions may produce structured queries and/or ranking parameters that may be used in a component of the content item retrieval system. Even when a decoder function is implemented to decode the response, the overall speed of content retrieval is faster because the large language model does not need to generate natural language responses, data structures, or structured queries. Exemplary decoder functions are illustrated as encoded values to structured query translator 460 and encoded values to ranking parameter(s) translator 480.

In some embodiments, context understanding part 120 may include one or more of: one or more large language models and one or more natural language processing models. The one or more models may operate as an encoder. The one or more models may output one or more encoded values, e.g., one or more encoded values 410 and one or more encoded values 420.

Context understanding part 120 may receive a context (e.g., context 180 of FIG. 1). The context may include a natural language query from a user. The context may include one or more contextual factors about the user or the context. The context may include one or more contextual factors about a user session. The context may include one or more contextual factors about device used by the user.

Context understanding part 120 may input or provide, to a large language model in context understanding part 120, a prompt comprising the context and an instruction to produce a response about the context in an encoded output format. The large language model may receive the prompt. An example of a prompt may include:

PROMPT

Produce a binary string as output that satisfies the following
1. If user intent is to watch a free movie than 1 else 0
2. if user has mentioned an actor name in the query then 1 else 0
3. if user has mentioned a title in query then 1 else 0
Respond for the user query “recommend me movies of Brad Pitt that are free to watch”

The prompt above is instructing the large language model to respond with information about three attributes: “whether user intent is to watch a free movie”, “whether user has mentioned an actor name in the query”, and “whether user has mentioned a title in query”.

The large language model operating as an encoder may generate a response based on the prompt. The response may include one or more encoded values. The one or more encoded values may correspond to one or more attributes about the context. In response to the prompt above, the large language model operating as an encoder may generate a response having one or more encoded values that correspond to the three attributes. An example of a response may include:

RESPONSE

110

In the example above, the response may include just a single token, “110”. However, the single token can effectively communicate and include information about three attribute-value pairs, “whether user intent is to watch a free movie YES”, “whether user has mentioned an actor name in the query YES”, and “whether user has mentioned a title in query NO”. The single token may indicate that the user intent is to watch a free movie, that the user has mentioned an actor name, and that the user has not mentioned a title.

Depending on the implementation of the large language model, the response in the example above may include three tokens, “1”, “1”, “0”. The three tokens can effectively communicate and include information about three attribute-value pairs, “whether user intent is to watch a free movie YES”, “whether user has mentioned an actor name in the query YES”, and “whether user has mentioned a title in query NO”. The three tokens may indicate that the user intent is to watch a free movie, that the user has mentioned an actor name, and that the user has not mentioned a title.

The large language model operating as an encoder may generate a response having far fewer tokens than a large language model that is generating a natural language response, or a large language model that is generating one or more attribute-value pairs (e.g., a data structure). Therefore, the large language model operating as an encoder may operate much faster, which may in turn decrease latency of returning results back to the user.

A large language model operating as an encoder can be used effectively when the response expected from the large language model predicts attributes about the context. The large language model operating as an encoder may be instructed to respond using one or more encoded values that represent or encode one or more attributes about the context, as opposed to instructing the large language model to respond using natural language, a data structure, or a structured query. One or more encoded values may indicate one or more selections from corresponding fixed set of possible attribute values (e.g., answers, choices, or options). The large language model operating as an encoder may be instructed to respond according to an encoding scheme, where encoded values may be assigned to different possible attribute values, or different possible responses to one or more questions in the prompt about the context.

In the example above, the large language model is instructed to respond about three attributes/questions, where each attribute may have two possible attribute values, or each question may have two possible answers:

| ATTRIBUTE | POSSIBLE ATTRIBUTE VALUES |
|---|---|
| whether user intent is to watch a free movie | YES, NO |
| whether user has mentioned an actor name in | YES, NO |
| the query | |
| whether user has mentioned a title in query | YES, NO |

Rather than responding using the attribute values, or in the form of a data structure, the large language model is instructed to respond using a binary string having one or more encoded values that have been assigned to the possible attribute values (e.g., according to an encoding scheme):

| | ENCODED VALUE(S) ASSIGNED TO | |
|---|---|---|
| ATTRIBUTE | POSSIBLE ATTRIBUTE VALUES | |
| whether user intent is to watch a free movie | “1” if YES | “0” if NO |
| whether user has mentioned an actor name | “1” if YES | “0” if NO |
| in the query | | |
| whether user has mentioned a title in query | “1” if YES | “0” if NO |

The large language model generate a response having one or more encoded values in accordance with the encoding scheme. Possible responses (e.g., 8 possible responses) may include:

| whether user intent | whether user has | whether user has | Response having |
|---|---|---|---|
| is to watch a free | mentioned an actor | mentioned a title in | one or more |
| movie | name in the query | query | encoded values |
| YES | YES | YES | “111” |
| YES | YES | NO | “110” |
| YES | NO | YES | “101” |
| YES | NO | NO | “100” |
| NO | YES | YES | “011” |
| NO | YES | NO | “010” |
| NO | NO | YES | “001” |
| NO | NO | NO | “000” |

In a different implementation, the large language model may have the following possible responses using ciphers or symbols in accordance with a different encoding scheme. In this encoding scheme, a cipher or symbol can indicate or encode a particular combination of answers. The cipher or symbol may indicate or encode a specific combination of attribute values or selections. Possible ciphers/symbols (e.g., 8 possible ciphers/symbols) may include:

| | | | Response having one |
|---|---|---|---|
| whether user intent | whether user has | whether user has | or more encoded |
| is to watch a free | mentioned an actor | mentioned a title in | values |
| movie | name in the query | query | (cipher/symbol) |
| YES | YES | YES | “A” |
| YES | YES | NO | “B” |
| YES | NO | YES | “C” |
| YES | NO | NO | “D” |
| NO | YES | YES | “E” |
| NO | YES | NO | “F” |
| NO | NO | YES | “G” |
| NO | NO | NO | “H” |

In some embodiments, the instruction in the prompt to the large language model operating as an encoder may include a first question about the context with at least two or more possible answers. The one or more encoded values in the response generated by the large language model can indicate one of the at least two or more possible answers to the first question. For example, a response having “0” may indicate or encode an answer to the first question. In some embodiments, the instruction may further include a second question about the context with at least two or more further possible answers. The one or more encoded values in the response generated by the large language model can indicate one of the at least two or more possible answers to the first question and one of the at least two or more further possible answers to the second question. For example, a response having “01” may indicate or encode an answer to the first question and an answer to the second question.

In some embodiments, the one or more encoded value can include a first encoded value that indicate both the one of the at least two or more possible answers to the first question and the one of the at least two or more further possible answers. For example, a response having “B” may indicate or encode two or more answers to two or more questions in the prompt, provided that the encoding scheme encodes a combination of an answer to the first question and an answer to the second question using a single encoded value.

The encoding scheme may be applicable to other types of questions/attributes with more than two possible answers or possible attribute values. An encoding scheme can be implemented to encode the two or more possible answers by assigning appropriate encoding values to the two or more possible answers.

In some embodiments, a response can include a binary string. The binary string may include one or more binary values, e.g., “010”.

In some embodiments, a response can include a numeric string. The numeric string may include one or more numbers, e.g., “412”.

In some embodiments, a response can include a character string. The character string may include one or more characters, e.g., “DA”.

In some embodiments, a response can include an alphanumeric string. The character string may include one or more characters, e.g., “1B”.

The one or more encoded values in the response may indicate one or more attributes about the context. The encoded values can be decoded (or translated) in accordance with the encoding scheme and used by one or more parts in a content item retrieval system. The encoded values may be used as control signals that may control one or more parts in a content item retrieval system.

In some embodiments, the one or more encoded values 410 may be used in a candidate generation part of a content item retrieval system (e.g., in candidate generation part 130 of the FIGS.). As illustrated, the one or more encoded values 410 may be provided to structured query builder 466 of a candidate generation part to generate a structured query. One or more encoded values 410 may correspond to one or more attributes about the context. The one or more attributes can include one or more intents 202, e.g., an intent of the context usable by a retrieval engine, e.g., a retrieval engine in a candidate generation part, to filter content items. The one or more attributes can include a selection of one or more retrieval engine(s) 208, e.g., an identification of the retrieval engine suitable for the context. The one or more attributes can include a selection of one or more content libraries 210, e.g., an identification of the content library suitable for the context. The one or more attributes can include one or more regular expressions 206.

Structured query builder 220 may receive, from the large language model, the response based on the prompt. The response may include one or more encoded values 410. Structured query builder 220 may include encoded values to structured query translator 460, which may decode the response having the one or more encoded values 410 (e.g., determine attributes corresponding to one or more encoded values 410). Encoded values to structured query translator 460 may translate the one or more encoded values 410 into a structured query 292. Encoded values to structured query translator 460 may apply the one or more encoded values 410 to structured query generation logic that produces structured queries conditioned on the one or more encoded values 410. The structured query generation logic may include conditional logic or scripting that takes the one or more encoded values 410, decode the one or more encoded values 410 according to the encoding scheme, and generates structured query 292. The conditional logic can be very fast relative to the speed of a large language model generating the same structured query 292. The structured query 292 may be input into a retrieval engine (e.g., a candidate generation part) to retrieve content items that correspond to the context from a content library. Structured query 292 may be used in candidate generation part as described in FIG. 2. The retrieved content items may be output to a user.

In some embodiments, the one or more encoded values may be used in a candidate ranking part of a content item retrieval system (e.g., in candidate ranking part 140 of the FIGS.). As illustrated, the one or more encoded values 420 may be provided to ranking parameter(s) processing part 488 of a candidate ranking part to augment ranking of relevant candidates. One or more encoded values 420 may correspond to one or more attributes about the context. The one or more attributes can include one or more intents 202, e.g., an intent of the context usable by a ranking engine, e.g., a component in a candidate ranking part, to in scoring the content items. The one or more attributes can include one or more rows usable by the ranking engine in categorizing the content items.

Ranking parameter(s) processing part 488 may receive, from the large language model, the response based on the prompt. The response may include one or more encoded values 420. Ranking parameter(s) processing part 488 may include encoded values to ranking parameter(s) translator 480, which may decode the response having the one or more encoded values 420 (e.g., determine attributes corresponding to one or more encoded values 420). Encoded values to ranking parameter(s) translator 480 may translate the one or more encoded values 420 into one or more ranking parameters 366. Encoded values to ranking parameter(s) translator 480 may apply the one or more encoded values 410 to ranking parameters generation logic that produces ranking parameters conditioned on the one or more encoded values 420. The ranking parameters generation logic may include conditional logic or scripting that takes the one or more encoded values 420, decode the one or more encoded values 420 according to the encoding scheme, and generates one or more ranking parameters 366 or instructions to a ranking engine to use one or more ranking parameters 366. The conditional logic can be very fast relative to a speed of a large language model generating the same one or more ranking parameters 366. The one or more ranking parameters 366 may be input into a ranking engine (e.g., a component in a candidate ranking part) to rank content items that correspond to the context using the one or more ranking parameters 366. One or more ranking parameters 366 may be used in candidate ranking part as described in FIG. 3. The ranked content items may be output to a user.

In some cases, candidate generation part 130 and/or candidate ranking part 140 may be implemented with logic that is controllable by one or more encoded values 410 and/or one or more encoded values 420. Candidate generation part 130 and/or candidate ranking part 140 may receive one or more encoded values 410 and/or one or more encoded values 420 as control signals. Candidate generation part 130 may generate relevant candidates in a manner according to one or more encoded values 410. Candidate ranking part 140 may rank relevant candidates according to one or more encoded values 420.

### Fine-Tuning a Large Language Model to Operate as an Encoder

FIG. 5 illustrates fine-tuning a large language model to output one or more encoded values, according to some embodiments of the disclosure. Off the shelf large language models are not trained or tuned to operate as an encoder. Off the shelf large language models may be trained or tuned to produce natural language responses, data structures, or structured queries. An off the shelf large language model may include previously trained large language model 504, which may be trained using a large volume of training data 502. Previously trained large language model 504 may generate predictions 506. Predictions 506 may include one or more of: natural language responses, data structures, or structured queries.

Previously trained large language model 504 may undergo fine-tuning process 560. Fine-tuning process 560 can fine-tune previously trained large language model 504 and turn previously trained large language model 504 into large language model as an encoder 534. Encoder 534 may generate predictions 536. Predictions 536 may include responses having one or more encoded values.

Fine-tuning process 560 may involve using training data 532. Fine-tuning process 560 may include update 572 (e.g., an update function). Update 572 may update one or more (trained/learned) parameters of previously trained large language model 504 based on the predictions 536 made in response to training data 532. Training data 532 may include prompts and ground-truth responses. Fine-tuning process 560 may further train previously trained large language model 504 (e.g., update one or more (trained/learned) parameters of previously trained large language model 504) using a custom data set, e.g., training data 532, to adapt previously trained large language model 504 to generate responses having one or more encoded values. Examples of fine-tuning process 560 may include parameter-efficient fine-tuning, low-rank adaptation of large language models, low-rank adaptation of large language models with quantized precision of weight parameters, updating of parameters with quantized precision, etc.

In some embodiments, prompts in training data 532 may be input into a previously trained large language model 504. A first prompt of the prompts can include a context having a natural language query for content items (e.g., a natural language query provided by a user, a natural language query generated by a generative machine learning model). The first prompt may include an instruction to produce a response about the context in an encoded output format. The instruction may prompt previously trained large language model 504 to follow an encoding scheme when generating a response to the first prompt. The context in the first prompt may include one or more contextual factors. Other prompts of the prompts may have similar properties of the first prompt, but with other natural language queries and optionally one or more other contextual factors. Update 572 may observe predictions 536 generated by the previously trained large language model (shown as large language model as an encoder 534 in training) in response to the prompts in training data 532. Update 572 may compare the predictions 536 against ground-truth responses in training data 532 to the prompts. A first ground-truth response of the ground-truth responses comprises one or more encoded values corresponding to one or more attributes about the context. Other ground-truth responses of the ground-truth responses may have similar properties as the first ground-truth response. Update 572 may update one or more parameters of the previously trained large language model (shown as large language model as an encoder 534 in training) based on the comparing.

Training data 532 for this specialized task of generating encoded values as responses may not be readily available. In some cases, procedures may be implemented to produce training data 532.

In some cases, data having prompts and generated responses using previously trained large language model 504 may be processed so that the prompts include an instruction to generate responses in an encoded output format and that the responses are converted into an encoded output format. The prompts and the converted responses can be used as training data 532.

One exemplary procedure to generate training data 532 includes convert generated data structures to encoded values 580. Convert generated data structures to encoded values 580 may retrieve (past) structured data responses generated by the previously trained large language model 504 in response to further prompts. A first further prompt of the further prompts can include the context and a further instruction to produce a further response about the context in a structured data format. Convert generated data structures to encoded values 580 may convert the structured data responses into the ground-truth responses (e.g., by applying a suitable encoding scheme). Convert generated data structures to encoded values 580 may also modify the further prompts to include an instruction to produce a response about the context in an encoded output format. The modified prompts and the converted ground-truth responses in the encoded output format may be used as training data 532.

In some cases, a (different) large language model can be used to generate natural language queries and optionally one or more contextual factors based on a set of attribute values. The generated natural language queries and optionally one or more generated contextual factors can be put into prompts that include an instruction to generate responses in an encoded output format. The set of attribute values may be converted into responses in an encoded output format. The prompts and the converted responses can be used as training data 532.

Another exemplary procedure to generate training data 532 includes generate training data matching data structure 590. Generate training data matching data structure 590 can leverage a large language model that may generate natural language responses to generate training data 532. Generate training data matching data structure 590 can determine possible variations of structured data responses having different values for the one or more attributes. In some cases, generate training data matching data structure 590 possible variations of responses in an encoded output format, and apply a decoding function to produce the possible variations of structured data responses having different values for the one or more attributes. Generate training data matching data structure 590, for a first possible variation of the possible variations having one or more first values to the one or more attributes, can input an instruction (or a prompt having the instruction) to a further large language model to generate one or more contexts that exhibit the one or more first values to the one or more attributes. In other words, generate training data matching data structure 590 may instruct the further large language model to generate one or more natural language queries that may have or match the one or more attributes of a given possible data structure. The one or more generated contexts can include one or more natural language queries. The one or more generated contexts are to be used in the prompts in training data 532 to the previously trained large language model (shown as large language model as an encoder 534 in training). Generate training data matching data structure 590 may encode the one or more first values to the one or more attributes into a first ground-truth response of the ground-truth responses in training data 532. Generate training data matching data structure 590 may convert the one or more first values to the one or more attributes into a response in an encoded output format. Multiple generated contexts and corresponding ground-truth response can be used as multiple entries in training data 532.

### Exemplary Methods for Content Item Retrieval

FIG. 6 is a flowchart showing method 600 for content item retrieval, according to some embodiments of the disclosure. Method 600 may be implemented in content item retrieval system 100, e.g., in context understanding part 120 and candidate generation part 130, in the FIGS.

In 602, a context may be received. The context may include a natural language query from a user. An example of a context is illustrated in FIG. 1 as context 180.

In 604, a prompt may be input into a large language model, such as a large language model operating as an encoder as described herein. The prompt may include the context and an instruction to produce a response about the context in an encoded output format.

In 606, the response generated based on the prompt may be received from the large language model. The response can include one or more encoded values corresponding to one or more attributes about the context.

In 608, the one or more encoded values may be translated into a structured query.

In 610, the structured query may be input into a retrieval engine to retrieve content items that correspond to the context from a content library.

In 612, the content items can be output to the user.

FIG. 7 is a flowchart showing method 700 for ranking content items, according to some embodiments of the disclosure. Method 700 may be implemented in content item retrieval system 100, e.g., in context understanding part 120 and candidate ranking part 140, in the FIGS.

In 702, a context may be received. The context may include a natural language query from a user. An example of a context is illustrated in FIG. 1 as context 180.

In 704, a prompt may be input into a large language model, such as a large language model operating as an encoder as described herein. The prompt may include the context and an instruction to produce a response about the context in an encoded output format.

In 706, the response generated based on the prompt may be received from the large language model. The response can include one or more encoded values corresponding to one or more attributes about the context.

In 708, the one or more encoded values may be translated into one or more ranking parameters.

In 710, a ranking engine may rank content items that correspond to the context using the one or more ranking parameters.

In 712, ranked content items may be output to the user.

### Exemplary Methods for Fine-Tuning a Large Language Model

FIG. 8 is a flowchart showing method 800 for fine-tuning a large language model, according to some embodiments of the disclosure. Method 700 may be implemented using components illustrated in FIG. 5.

In 802, prompts may be input into a previously trained large language model. A first prompt of the prompts can include a context having a natural language query for content items, and an instruction to produce a response about the context in an encoded output format.

In 804, predictions generated by the previously trained large language model in response to the prompts can be observed.

In 806, the predictions may be compared against ground-truth responses to the prompts. A first ground-truth response of the ground-truth responses can include one or more encoded values corresponding to one or more attributes about the context.

In 810, one or more parameters of the previously trained large language model can be updated based on the comparing.

### Exemplary Computing Device

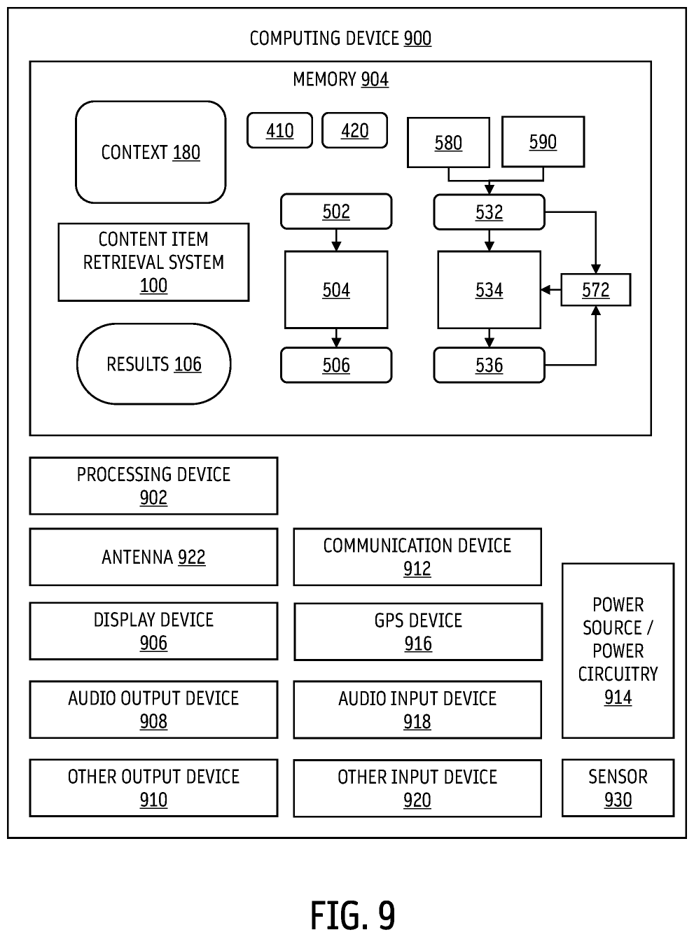

FIG. 9 is a block diagram of an exemplary computing device 900, according to some embodiments of the disclosure. One or more computing devices 900 may be used to implement the functionalities described with the FIGS. and herein. A number of components are illustrated in the FIGS. as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 8, and the computing device 900 may include interface circuitry for coupling to the one or more components. For example, the computing device 900 may not include a display device 906, and may include display device interface circuitry (e.g., a connector and driver circuitry) to which a display device 906 may be coupled. In another set of examples, the computing device 900 may not include an audio input device 918 or an audio output device 908 and may include audio input or output device interface circuitry (e.g., connectors and supporting circuitry) to which an audio input device 918 or audio output device 908 may be coupled.

The computing device 900 may include a processing device 902 (e.g., one or more processing devices, one or more of the same type of processing device, one or more of different types of processing device). The processing device 902 may include electronic circuitry that process electronic data from data storage elements (e.g., registers, memory, resistors, capacitors, quantum bit cells) to transform that electronic data into other electronic data that may be stored in registers and/or memory. Examples of processing device 902 may include a central processing unit (CPU), a graphics processing unit (GPU), a quantum processor, a machine learning processor, an artificial-intelligence processor, a neural network processor, an artificial-intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 904 includes one or more non-transitory computer-readable storage media. In some embodiments, memory 904 may include memory that shares a die with the processing device 902. In some embodiments, memory 904 includes one or more non-transitory computer-readable media storing instructions executable to perform operations described with the FIGS. and herein, such as the methods and operations illustrated in FIGS. 1-8. Exemplary parts that may be encoded as instructions and stored in memory 904 are depicted. Parts may include one or more components in content item retrieval system 100, such as context understanding part 120, candidate generation part 130, candidate ranking part 140, structured query builder 466, ranking parameter(s) processing part 488, etc. Memory 904 may store instructions that encode one or more exemplary parts. The instructions stored in the one or more non-transitory computer-readable media may be executed by processing device 902. In some embodiments, memory 904 may store data, e.g., data structures, binary data, bits, metadata, files, blobs, etc., as described with the FIGS. and herein. Exemplary data that may be stored in memory 904 are depicted. Data may include one or more of: context 180, results 106, one or more encoded values 410 and one or more encoded values 420. Data may include one or more of: structured query 292 and one or more ranking parameters 366. Memory 904 may store one or more data as depicted.

In some embodiments, memory 904 may store one or more machine learning models (and or parts thereof), such as a large language model as described herein (e.g., previously trained large language model 504, large language model as an encoder 534, and large language model in generate training data matching data structure 590). Memory 904 may store training data such as training data 502 and training data 532. Memory 904 may store instructions that perform operations associated with fine-tuning process 560 and update 572 of FIG. 5. Memory 904 may store input data, output data, intermediate outputs, intermediate inputs of one or more machine learning models. Memory 904 may store instructions to perform one or more operations of the machine learning model. Memory 904 may store one or more parameters used by the machine learning model. Memory 904 may store information that encodes how processing units of the machine learning model are connected with each other. Memory 904 may store instructions that perform operations associated with convert generated data structures to encoded values 580. Memory 904 may store instructions that perform operations associated with generate training data matching data structure 590.

In some embodiments, the computing device 900 may include a communication device 912 (e.g., one or more communication devices). For example, the communication device 912 may be configured for managing wired and/or wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 912 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 912 may operate in accordance with other wireless protocols in other embodiments. The computing device 900 may include an antenna 922 to facilitate wireless communications and/or to receive other wireless communications (such as radio frequency transmissions). The computing device 900 may include receiver circuits and/or transmitter circuits. In some embodiments, the communication device 912 may manage wired communications, such as electrical, optical, or any other suitable communication protocols (e.g., the Ethernet). As noted above, the communication device 912 may include multiple communication chips. For instance, a first communication device 912 may be dedicated to shorter-range wireless communications such as Wi-Fi or Bluetooth, and a second communication device 912 may be dedicated to longer-range wireless communications such as global positioning system (GPS), EDGE, GPRS, CDMA, WiMAX, LTE, EV-DO, or others. In some embodiments, a first communication device 912 may be dedicated to wireless communications, and a second communication device 912 may be dedicated to wired communications.

The computing device 900 may include power source/power circuitry 914. The power source/power circuitry 914 may include one or more energy storage devices (e.g., batteries or capacitors) and/or circuitry for coupling components of the computing device 900 to an energy source separate from the computing device 900 (e.g., DC power, AC power, etc.).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include an audio output device 908 (or corresponding interface circuitry, as discussed above). The audio output device 908 may include any device that generates an audible indicator, such as speakers, headsets, or earbuds, for example.

The computing device 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art

The computing device 900 may include a sensor 930 (or one or more sensors). The computing device 900 may include corresponding interface circuitry, as discussed above). Sensor 930 may sense physical phenomenon and translate the physical phenomenon into electrical signals that can be processed by, e.g., processing device 902. Examples of sensor 930 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 900 may include another output device 910 (or corresponding interface circuitry, as discussed above). Examples of the other output device 910 may include an audio codec, a video codec, a printer, a wired or wireless transmitter for providing information to other devices, haptic output device, gas output device, vibrational output device, lighting output device, home automation controller, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 900 may be any other electronic device that processes data.

### Select Examples

Example 1 provides a method, including receiving a context, where the context includes a natural language query from a user; inputting, into a large language model, a prompt including the context and an instruction to produce a response about the context in an encoded output format; receiving, from the large language model, the response generated based on the prompt, where the response includes one or more encoded values corresponding to one or more attributes about the context; translating the one or more encoded values into a structured query; inputting the structured query into a retrieval engine to retrieve content items that correspond to the context from a content library; and outputting the content items to the user.

Example 2 provides the method of example 1, where the context includes one or more contextual factors about the user.

Example 3 provides the method of example 1 or 2, where the context includes one or more contextual factors about a device used by the user.

Example 4 provides the method of any one of examples 1-3, where: the instruction includes a first question about the context with at least two or more possible answers; and the one or more encoded values in the response indicate one of the at least two or more possible answers to the first question.

Example 5 provides the method of example 4, where: the instruction includes a second question about the context with at least two or more further possible answers; and the one or more encoded values in the response indicate one of the at least two or more possible answers to the first question and one of the at least two or more further possible answers.

Example 6 provides the method of example 5, where the one or more encoded values include a first encoded value that indicates both the one of the at least two or more possible answers to the first question and the one of the at least two or more further possible answers to the second question.

Example 7 provides the method of any one of examples 1-6, where the encoded output format is a binary string, and the one or more encoded values include one or more binary values.

Example 8 provides the method of any one of examples 1-7, where the one or more attributes includes an intent of the context usable by the retrieval engine to filter content items.

Example 9 provides the method of any one of examples 1-8, where the one or more attributes includes an identification of the retrieval engine suitable for the context.

Example 10 provides the method of any one of examples 1-9, where the one or more attributes includes an identification of the content library suitable for the context.

Example 11 provides the method of any one of examples 1-10, where translating the one or more encoded values into the structured query includes applying the one or more encoded values to structured query generation logic that produces structured queries conditioned on the one or more encoded values.

Example 12 provides the method of any one of examples 1-11, where the response does not include natural language text.

Example 13 provides the method of any one of examples 1-12, where the response does not include one or more attribute-value pairs.

Example 14 provides a method, including receiving a context, where the context includes a natural language query from a user; inputting, into a large language model, a prompt including the context and an instruction to produce a response about the context in an encoded output format; receiving, from the large language model, the response generated based on the prompt, where the response includes one or more encoded values corresponding to one or more attributes about the context; translating the one or more encoded values into one or more ranking parameters; ranking, by a ranking engine, content items that correspond to the context using the one or more ranking parameters; and outputting ranked content items to the user.

Example 15 provides the method of example 14, where the context includes one or more contextual factors about the user.

Example 16 provides the method of example 14 or 15, where the context includes one or more contextual factors about a device used by the user.

Example 17 provides the method of any one of examples 14-16, where: the instruction includes a first question about the context with at least two or more possible answers; and the one or more encoded values in the response indicate one of the at least two or more possible answers to the first question.

Example 18 provides the method of example 17, where: the instruction includes a second question about the context with at least two or more further possible answers; and the one or more encoded values in the response indicate one of the at least two or more possible answers to the first question and one of the at least two or more further possible answers to the second question.

Example 19 provides the method of example 18, where the one or more encoded values include a first encoded value that indicate both the one of the at least two or more possible answers to the first question and the one of the at least two or more further possible answers.

Example 20 provides the method of any one of examples 14-19, where the encoded output format is a binary string, and the one or more encoded values include one or more binary values.

Example 21 provides the method of any one of examples 14-20, where the one or more attributes includes an intent of the context usable by the ranking engine in scoring the content items.

Example 22 provides the method of any one of examples 14-21, where the one or more attributes includes one or more rows usable by the ranking engine in categorizing the content items.

Example 23 provides the method of any one of examples 14-22, where translating the one or more encoded values into the one or more ranking parameters includes applying the one or more encoded values to ranking parameters generation logic that produces ranking parameters conditioned on the one or more encoded values.

Example 24 provides the method of any one of examples 14-23, where the response does not include natural language text.

Example 25 provides the method of any one of examples 14-24, where the response does not include one or more attribute-value pairs.

Example 26 provides a method, including inputting prompts into a previously trained large language model, where a first prompt of the prompts includes a context having a natural language query for content items, and an instruction to produce a response about the context in an encoded output format; observing predictions generated by the previously trained large language model in response to the prompts; comparing the predictions against ground-truth responses to the prompts, where a first ground-truth response of the ground-truth responses includes one or more encoded values corresponding to one or more attributes about the context; and updating one or more parameters of the previously trained large language model based on the comparing.

Example 27 provides the method of example 26, where the context further includes one or more contextual factors.

Example 28 provides the method of example 26 or 27, further including retrieving structured data responses generated by the previously trained large language model in response to further prompts, where a first further prompt of the further prompts has the context and a further instruction to produce a further response about the context in a structured data format; and converting the structured data responses into the ground-truth responses.

Example 29 provides the method of any one of examples 26-28, further including determining possible variations of structured data responses having different values for the one or more attributes; and for a first possible variation of the possible variations having one or more first values to the one or more attributes, inputting an instruction to a further large language model to generate one or more contexts that exhibit the one or more first values to the one or more attributes, where the one or more generated contexts include one or more natural language queries, and the one or more generated contexts are to be used in the prompts to the previously trained large language model; and encoding the one or more first values to the one or more attributes into a first ground-truth response of the ground-truth responses.

Example 30 provides one or more non-transitory computer-readable media storing instructions that, when executed by one or more processors, cause the one or more processors to: receive a context, where the context includes a natural language query from a user; input, into a large language model, a prompt including the context and an instruction to produce a response about the context in an encoded output format; receive, from the large language model, the response generated based on the prompt, where the response includes one or more encoded values corresponding to one or more attributes about the context; translate the one or more encoded values into a structured query; input the structured query into a retrieval engine to retrieve content items that correspond to the context from a content library; and output the content items to the user.

Example 31 provides the one or more non-transitory computer-readable media of example 30, where the context includes one or more contextual factors about the user.

Example 32 provides the one or more non-transitory computer-readable media of example 30 or 31, where the context includes one or more contextual factors about a device used by the user.

Example 33 provides the one or more non-transitory computer-readable media of any one of examples 30-32, where: the instruction includes a first question about the context with at least two or more possible answers; and the one or more encoded values in the response indicate one of the at least two or more possible answers to the first question.

Example 34 provides the one or more non-transitory computer-readable media of example 33, where: the instruction includes a second question about the context with at least two or more further possible answers; and the one or more encoded values in the response indicate one of the at least two or more possible answers to the first question and one of the at least two or more further possible answers.

Example 35 provides the one or more non-transitory computer-readable media of example 34, where the one or more encoded values include a first encoded value that indicates both the one of the at least two or more possible answers to the first question and the one of the at least two or more further possible answers to the second question.

Example 36 provides the one or more non-transitory computer-readable media of any one of examples 30-35, where the encoded output format is a binary string, and the one or more encoded values include one or more binary values.

Example 37 provides the one or more non-transitory computer-readable media of any one of examples 30-36, where the one or more attributes includes an intent of the context usable by the retrieval engine to filter content items.

Example 38 provides the one or more non-transitory computer-readable media of any one of examples 30-37, where the one or more attributes includes an identification of the retrieval engine suitable for the context.

Example 39 provides the one or more non-transitory computer-readable media of any one of examples 30-38, where the one or more attributes includes an identification of the content library suitable for the context.

Example 40 provides the one or more non-transitory computer-readable media of any one of examples 30-39, where translating the one or more encoded values into the structured query includes applying the one or more encoded values to structured query generation logic that produces structured queries conditioned on the one or more encoded values.

Example 41 provides the one or more non-transitory computer-readable media of any one of examples 30-40, where the response does not include natural language text.

Example 42 provides the one or more non-transitory computer-readable media of any one of examples 30-41, where the response does not include one or more attribute-value pairs.

Example 43 provides one or more non-transitory computer-readable media storing instructions that, when executed by one or more processors, cause the one or more processors to: receive a context, where the context includes a natural language query from a user; input, into a large language model, a prompt including the context and an instruction to produce a response about the context in an encoded output format; receive, from the large language model, the response generated based on the prompt, where the response includes one or more encoded values corresponding to one or more attributes about the context; translate the one or more encoded values into one or more ranking parameters; rank, by a ranking engine, content items that correspond to the context using the one or more ranking parameters; and output ranked content items to the user.

Example 44 provides the one or more non-transitory computer-readable media of example 43, where the context includes one or more contextual factors about the user.

Example 45 provides the one or more non-transitory computer-readable media of example 43 or 44, where the context includes one or more contextual factors about a device used by the user.

Example 46 provides the one or more non-transitory computer-readable media of any one of examples 43-45, where: the instruction includes a first question about the context with at least two or more possible answers; and the one or more encoded values in the response indicate one of the at least two or more possible answers to the first question.

Example 47 provides the one or more non-transitory computer-readable media of example 46, where: the instruction includes a second question about the context with at least two or more further possible answers; and the one or more encoded values in the response indicate one of the at least two or more possible answers to the first question and one of the at least two or more further possible answers to the second question.

Example 48 provides the one or more non-transitory computer-readable media of example 47, where the one or more encoded values include a first encoded value that indicate both the one of the at least two or more possible answers to the first question and the one of the at least two or more further possible answers.

Example 49 provides the one or more non-transitory computer-readable media of any one of examples 43-48, where the encoded output format is a binary string, and the one or more encoded values include one or more binary values.

Example 50 provides the one or more non-transitory computer-readable media of any one of examples 43-49, where the one or more attributes includes an intent of the context usable by the ranking engine in scoring the content items.

Example 51 provides the one or more non-transitory computer-readable media of any one of examples 43-50, where the one or more attributes includes one or more rows usable by the ranking engine in categorizing the content items.

Example 52 provides the one or more non-transitory computer-readable media of any one of examples 43-51, where translating the one or more encoded values into the one or more ranking parameters includes applying the one or more encoded values to ranking parameters generation logic that produces ranking parameters conditioned on the one or more encoded values.

Example 53 provides the one or more non-transitory computer-readable media of any one of examples 43-52, where the response does not include natural language text.

Example 54 provides the one or more non-transitory computer-readable media of any one of examples 43-53, where the response does not include one or more attribute-value pairs.

Example 55 provides one or more non-transitory computer-readable media storing instructions that, when executed by one or more processors, cause the one or more processors to: input prompts into a previously trained large language model, where a first prompt of the prompts includes a context having a natural language query for content items, and an instruction to produce a response about the context in an encoded output format; observe predictions generated by the previously trained large language model in response to the prompts; compare the predictions against ground-truth responses to the prompts, where a first ground-truth response of the ground-truth responses includes one or more encoded values corresponding to one or more attributes about the context; and update one or more parameters of the previously trained large language model based on the comparing.

Example 56 provides the one or more non-transitory computer-readable media of example 55, where the context further includes one or more contextual factors.

Example 57 provides the one or more non-transitory computer-readable media of example 55 or 56, where the instructions further cause the one or more processors to: retrieve structured data responses generated by the previously trained large language model in response to further prompts, where a first further prompt of the further prompts has the context and a further instruction to produce a further response about the context in a structured data format; and convert the structured data responses into the ground-truth responses.

Example 58 provides the one or more non-transitory computer-readable media of any one of examples 55-57, where the instructions further cause the one or more processors to: determine possible variations of structured data responses having different values for the one or more attributes; and for a first possible variation of the possible variations having one or more first values to the one or more attributes, input an instruction to a further large language model to generate one or more contexts that exhibit the one or more first values to the one or more attributes, where the one or more generated contexts include one or more natural language queries, and the one or more generated contexts are to be used in the prompts to the previously trained large language model; and encode the one or more first values to the one or more attributes into a first ground-truth response of the ground-truth responses.

Example 59 provides a system including one or more processors; and one or more non-transitory computer-readable media storing instructions that, when executed by the one or more processors, cause the one or more processors to: receive a context, where the context includes a natural language query from a user; input, into a large language model, a prompt including the context and an instruction to produce a response about the context in an encoded output format; receive, from the large language model, the response generated based on the prompt, where the response includes one or more encoded values corresponding to one or more attributes about the context; translate the one or more encoded values into a structured query; input the structured query into a retrieval engine to retrieve content items that correspond to the context from a content library; and output the content items to the user.

Example 60 provides the system of example 59, where the context includes one or more contextual factors about the user.

Example 61 provides the system of example 59 or 60, where the context includes one or more contextual factors about a device used by the user.

Example 62 provides the system of any one of examples 59-61, where: the instruction includes a first question about the context with at least two or more possible answers; and the one or more encoded values in the response indicate one of the at least two or more possible answers to the first question.

Example 63 provides the system of example 62, where: the instruction includes a second question about the context with at least two or more further possible answers; and the one or more encoded values in the response indicate one of the at least two or more possible answers to the first question and one of the at least two or more further possible answers.

Example 64 provides the system of example 63, where the one or more encoded values include a first encoded value that indicates both the one of the at least two or more possible answers to the first question and the one of the at least two or more further possible answers to the second question.

Example 65 provides the system of any one of examples 59-64, where the encoded output format is a binary string, and the one or more encoded values include one or more binary values.

Example 66 provides the system of any one of examples 59-65, where the one or more attributes includes an intent of the context usable by the retrieval engine to filter content items.

Example 67 provides the system of any one of examples 59-66, where the one or more attributes includes an identification of the retrieval engine suitable for the context.

Example 68 provides the system of any one of examples 59-67, where the one or more attributes includes an identification of the content library suitable for the context.

Example 69 provides the system of any one of examples 59-68, where translating the one or more encoded values into the structured query includes applying the one or more encoded values to structured query generation logic that produces structured queries conditioned on the one or more encoded values.

Example 70 provides the system of any one of examples 59-69, where the response does not include natural language text.

Example 71 provides the system of any one of examples 59-70, where the response does not include one or more attribute-value pairs.

Example 72 provides a system including one or more processors; and one or more non-transitory computer-readable media storing instructions that, when executed by the one or more processors, cause the one or more processors to: receive a context, where the context includes a natural language query from a user; input, into a large language model, a prompt including the context and an instruction to produce a response about the context in an encoded output format; receive, from the large language model, the response generated based on the prompt, where the response includes one or more encoded values corresponding to one or more attributes about the context; translate the one or more encoded values into one or more ranking parameters; rank, by a ranking engine, content items that correspond to the context using the one or more ranking parameters; and output ranked content items to the user.

Example 73 provides the system of example 72, where the context includes one or more contextual factors about the user.

Example 74 provides the system of example 72 or 73, where the context includes one or more contextual factors about a device used by the user.

Example 75 provides the system of any one of examples 72-74, where: the instruction includes a first question about the context with at least two or more possible answers; and the one or more encoded values in the response indicate one of the at least two or more possible answers to the first question.

Example 76 provides the system of example 75, where: the instruction includes a second question about the context with at least two or more further possible answers; and the one or more encoded values in the response indicate one of the at least two or more possible answers to the first question and one of the at least two or more further possible answers to the second question.

Example 77 provides the system of example 76, where the one or more encoded values include a first encoded value that indicate both the one of the at least two or more possible answers to the first question and the one of the at least two or more further possible answers.

Example 78 provides the system of any one of examples 72-77, where the encoded output format is a binary string, and the one or more encoded values include one or more binary values.

Example 79 provides the system of any one of examples 72-78, where the one or more attributes includes an intent of the context usable by the ranking engine in scoring the content items.

Example 80 provides the system of any one of examples 72-79, where the one or more attributes includes one or more rows usable by the ranking engine in categorizing the content items.

Example 81 provides the system of any one of examples 72-80, where translating the one or more encoded values into the one or more ranking parameters includes applying the one or more encoded values to ranking parameters generation logic that produces ranking parameters conditioned on the one or more encoded values.

Example 82 provides the system of any one of examples 72-81, where the response does not include natural language text.

Example 83 provides the system of any one of examples 72-82, where the response does not include one or more attribute-value pairs.

Example 84 provides a system including one or more processors; and one or more non-transitory computer-readable media storing instructions that, when executed by the one or more processors, cause the one or more processors to: input prompts into a previously trained large language model, where a first prompt of the prompts includes a context having a natural language query for content items, and an instruction to produce a response about the context in an encoded output format; observe predictions generated by the previously trained large language model in response to the prompts; compare the predictions against ground-truth responses to the prompts, where a first ground-truth response of the ground-truth responses includes one or more encoded values corresponding to one or more attributes about the context; and update one or more parameters of the previously trained large language model based on the comparing.

Example 85 provides the system of example 84, where the context further includes one or more contextual factors.

Example 86 provides the system of example 84 or 85, where the instructions further cause the one or more processors to: retrieve structured data responses generated by the previously trained large language model in response to further prompts, where a first further prompt of the further prompts has the context and a further instruction to produce a further response about the context in a structured data format; and convert the structured data responses into the ground-truth responses.

Example 87 provides the system of any one of examples 84-86, where the instructions further cause the one or more processors to: determine possible variations of structured data responses having different values for the one or more attributes; and for a first possible variation of the possible variations having one or more first values to the one or more attributes, input an instruction to a further large language model to generate one or more contexts that exhibit the one or more first values to the one or more attributes, where the one or more generated contexts include one or more natural language queries, and the one or more generated contexts are to be used in the prompts to the previously trained large language model; and encode the one or more first values to the one or more attributes into a first ground-truth response of the ground-truth responses.

Example A provides one or more non-transitory computer-readable media storing instructions that, when executed by one or more processors, cause the one or more processors to perform any one of the methods provided in examples 1-29 and FIGS. 6-8.

Example B provides an apparatus comprising means to carry out or means for carrying out any one of the computer-implemented methods provided in examples 1-29 and FIGS. 6-8.

Example C provides a computer-implemented system, comprising one or more processors, and one or more non-transitory computer-readable media storing instructions that, when executed by the one or more processors, cause the one or more processors to perform any one of the methods provided in examples 1-29 and FIGS. 6-8.

Example D provides a computer-implemented system comprising one or more components illustrated in any one of FIGS. 1-5 and 9 to perform operations described herein.

### Variations and Other Notes

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

A large language model, as used herein, describes a machine learning model, or a deep learning model. A large language model may include many neural network layers, such as recurrent layers, feedforward layers, embedding layers, and attention layers. A neural network layer may include one or more neurons or nodes, where a neuron or node may perform a function and/or operation on input(s) to generate output(s) according to one or more (trained/learned) parameters. These neural network layers work together to process the input text and generate output content by making predictions of the next token in the output content. The embedding layer can create embeddings from the input text, while the attention layer may weigh the importance of different tokens in a sequence, allowing the large language model to capture dependencies and relationships. A recurrent layer is a type of neural network layer that allows the model to process sequences of variable length. It does this by maintaining a hidden state that is updated at each time step, allowing the model to remember information from previous time steps. The feedforward layer is a type of neural network layer that applies a linear transformation to the input data, followed by a non-linear activation function. The embedding layer is a type of neural network layer that maps discrete tokens to continuous vectors, allowing the model to process text data. The attention layer is a type of neural network layer that allows the model to focus on different parts of the input sequence, depending on the task at hand. The attention layer may be transformer-based. The transformer architecture introduced parallel processing to sequences and effectively addressed the issues of long-range dependencies through self-attention mechanisms. The attention mechanism computes a weighted sum of input values (or values from the previous layer), where the weights are decided based on the query, key, and value representations of the data. In the context of large language models, the attention layer is a component that enables the model to capture long-range dependencies and contextual information. The attention mechanism enables the model to focus on specific parts of the input text that are relevant to the task at hand, allowing it to generate more accurate outputs.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
receiving a context, wherein the context includes a natural language query from a user;
inputting, into a large language model, a prompt comprising the context and an instruction to produce a response about the context in an encoded output format;
receiving, from the large language model, the response generated based on the prompt, wherein the response comprises one or more encoded values corresponding to one or more attributes about the context;
translating the one or more encoded values into a structured query;
inputting the structured query into a retrieval engine to retrieve content items that correspond to the context from a content library; and
outputting the content items to the user.

2. The method of claim 1, wherein the context includes one or more contextual factors about the user.

3. The method of claim 1, wherein the context includes one or more contextual factors about a device used by the user.

4. The method of claim 1, wherein:
the instruction comprises a first question about the context with at least two or more possible answers; and
the one or more encoded values in the response indicate one of the at least two or more possible answers to the first question.

5. The method of claim 4, wherein:
the instruction comprises a second question about the context with at least two or more further possible answers; and
the one or more encoded values in the response indicate one of the at least two or more possible answers to the first question and one of the at least two or more further possible answers.

6. The method of claim 5, wherein the one or more encoded values comprise a first encoded value that indicates both the one of the at least two or more possible answers to the first question and the one of the at least two or more further possible answers to the second question.

7. The method of claim 1, wherein the encoded output format is a binary string, and the one or more encoded values comprise one or more binary values.

8. The method of claim 1, wherein the one or more attributes comprises:
an intent of the context usable by the retrieval engine to filter content items.

9. The method of claim 1, wherein the one or more attributes comprises:
an identification of the retrieval engine suitable for the context.

10. The method of claim 1, wherein the one or more attributes comprises:
an identification of the content library suitable for the context.

11. The method of claim 1, wherein translating the one or more encoded values into the structured query comprises:
applying the one or more encoded values to structured query generation logic that produces structured queries conditioned on the one or more encoded values.

12. The method of claim 1, wherein the response does not include natural language text.

13. The method of claim 1, wherein the response does not include one or more attribute-value pairs.

14. One or more non-transitory computer-readable media storing instructions that, when executed by one or more processors, cause the one or more processors to:
receive a context, wherein the context includes a natural language query from a user;
input, into a large language model, a prompt comprising the context and an instruction to produce a response about the context in an encoded output format, wherein the encoded output format is a binary string;
receive, from the large language model, the response generated based on the prompt, wherein the response comprises one or more encoded values corresponding to one or more attributes about the context, and the one or more encoded values comprise one or more binary values;
translate the one or more encoded values into a structured query;
input the structured query into a retrieval engine to retrieve content items that correspond to the context from a content library; and
output the content items to the user.

15. The one or more non-transitory computer-readable media of claim 14, wherein:
the instruction comprises a first question about the context with at least two or more possible answers; and
the one or more encoded values in the response indicate one of the at least two or more possible answers to the first question.

16. The one or more non-transitory computer-readable media of claim 15, wherein:
the instruction comprises a second question about the context with at least two or more further possible answers; and
the one or more encoded values in the response indicate one of the at least two or more possible answers to the first question and one of the at least two or more further possible answers.

17. The one or more non-transitory computer-readable media of claim 16, wherein the one or more encoded values comprise a first encoded value that indicates both the one of the at least two or more possible answers to the first question and the one of the at least two or more further possible answers to the second question.

18. The one or more non-transitory computer-readable media of claim 14, wherein the one or more attributes comprises one or more of:
an intent of the context usable by the retrieval engine to filter content items;
an identification of the retrieval engine suitable for the context; and
an identification of the content library suitable for the context.

19. A system comprising:
one or more processors; and
one or more non-transitory computer-readable media storing instructions that, when executed by the one or more processors, cause the one or more processors to:
receive a context, wherein the context includes a natural language query from a user, one or more contextual factors about the user, and one or more contextual factors about a device used by the user;
input, into a large language model, a prompt comprising the context and an instruction to produce a response about the context in an encoded output format;
receive, from the large language model, the response generated based on the prompt, wherein the response comprises one or more encoded values corresponding to one or more attributes about the context;
translate the one or more encoded values into a structured query;
input the structured query into a retrieval engine to retrieve content items that correspond to the context from a content library; and
output the content items to the user.

20. The system of claim 19, wherein translating the one or more encoded values into the structured query comprises:
applying the one or more encoded values to structured query generation logic that produces structured queries conditioned on the one or more encoded values.
